(19) United States
(12) Patent Application Publication
(10) Pub. No.: US 2020/0198414 A1
(43) Pub. Date: Jun. 25, 2020

(54) METHOD AND APPARATUS FOR FORMING A COMPOSITE TREAD WITH MICROCHIMNEYS

(71) Applicant: The Goodyear Tire & Rubber Company, Akron, OH (US)

(72) Inventors: Hongbing Chen, Broadview Heights, OH (US); Christopher David Dyrlund, Canton, OH (US); Adam Mark Baldan, Akron, OH (US); Elizabeth Amelia Rogenski, Atwater, OH (US)

(21) Appl. No.: 16/595,814

(22) Filed: Oct. 8, 2019

Related U.S. Application Data
(60) Provisional application No. 62/781,768, filed on Dec. 19, 2018.

(51) Int. Cl. B60C 19/08; B29D 30/60; B29D 30/30

(52) U.S. Cl. CPC B60C 19/082; B60C 2011/0091; B29D 30/3021; B29D 30/60

(57) ABSTRACT

A method for forming a composite tread with microchimneys, the method comprising the steps of providing a coextruded strip formed of a first compound and a second compound, wherein the first compound is a tread compound, and the second compound is electrically conductive, and then winding the coextruded strip onto a tire building drum to form a tread.

### FIELD OF THE INVENTION

The invention relates in general to tire manufacturing, and more particularly to a method for forming a composite tread and tire with microchimneys.

### BACKGROUND OF THE INVENTION

Tire manufacturers have progressed to more complicated designs due to an advance in technology as well as a highly competitive industrial environment. In particular, tire designers seek to use multiple rubber compounds in a tire tread in order to meet customer demands. Using multiple rubber compounds per tire component can result in a huge number of compounds needed to be on hand for the various tire lines of the manufacturer. In addition, modern tire tread design requires the use of a conductive rubber material in order to form a chimney in order to dissipate static electric charge. The tread with a chimney is typically made by extrusion, which increases the complexity of the splice bar design and die work. However, if there are any issues/inconsistencies with the extrusion, the conductive path can be broken and the tire will not properly dissipate the built up static charge.

Thus, it is desired to have an improved method and apparatus which provides independent flow of two or more compounds, including a conductive rubber material, from a single application head. More particularly, it is desired to be able to make a custom tire tread with conductive chimneys, directly onto a tire building machine in an efficient manner, reducing the need for multiple application stations. It is also desired to have a tire tread with multiple conductive chimneys, as opposed to a single chimney.

### Definitions

“Aspect Ratio” means the ratio of a tire's section height to its section width.

“Axial” and “axially” means the lines or directions that are parallel to the axis of rotation of the tire.

“Bead” or “Bead Core” means generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers.

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Cord” means one of the reinforcement strands, including fibers, which are used to reinforce the plies.

“Inner Liner” means the layer or layers of elastomer or other material that form the inside surface of a tubeless tire and that contain the inflating fluid within the tire.

“Inserts” means the reinforcement typically used to reinforce the sidewalls of runflat-type tires; it also refers to the elastomeric insert that underlies the tread.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which the ply cords which extend from bead to bead are laid at cord angles between 65° and 90° with respect to the equatorial plane of the tire.

“Sidewall” means a portion of a tire between the tread and the bead.

“Laminate structure” means an unvulcanized structure made of one or more layers of tire or elastomer components such as the innerliner, sidewalls, and optional ply layer.

### BRIEF DESCRIPTION OF THE DRAWINGS

The invention will be described by way of example and with reference to the accompanying drawings in which:

FIG. 1 is a cross-sectional view of a tire tread with microchimneys of the present invention;

FIG. 2A is a perspective view of a coextruded strip of 90% of a first compound and 10% of a second compound of the present invention; FIG. 2B is a perspective view of a coextruded strip of 95% of a first compound and 5% of a second compound;

FIG. 3 is a close up cross-sectional view of the tire tread of FIG. 1, formed with microchimneys;

FIG. 4 is a cross-sectional view of a green (uncured) tread formed from a single layer of spirally wound coextruded strips wherein the outer surfaces of each strip are oriented in the radial direction;

FIG. 5 is a close up cross-sectional view of a dual compound apparatus for forming a coextruded strip onto a tire building drum; and

FIG. 6A is a perspective cutaway view of a coextrusion nozzle of the present invention, while FIG. 6B is a side cross-sectional view of the coextrusion nozzle of FIG. 6A.

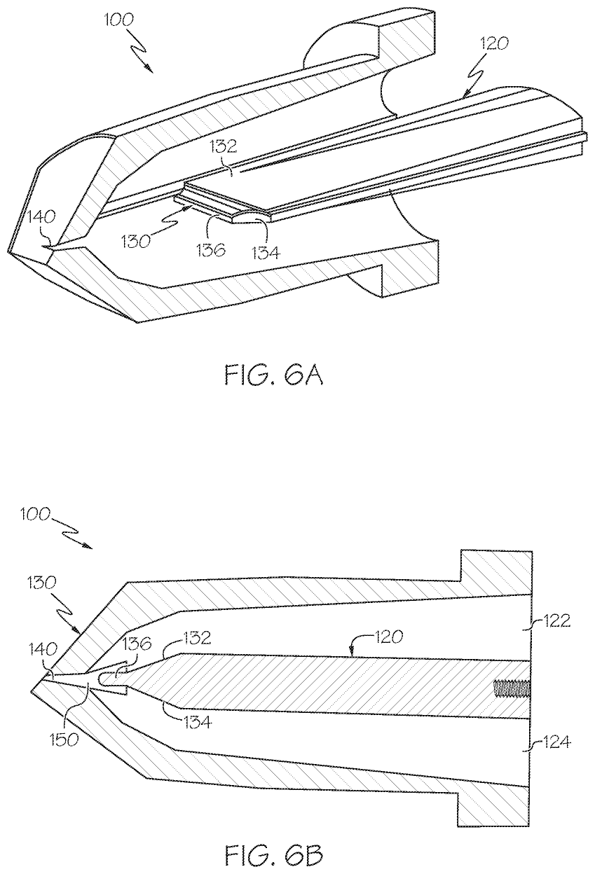

### DETAILED DESCRIPTION OF THE INVENTION

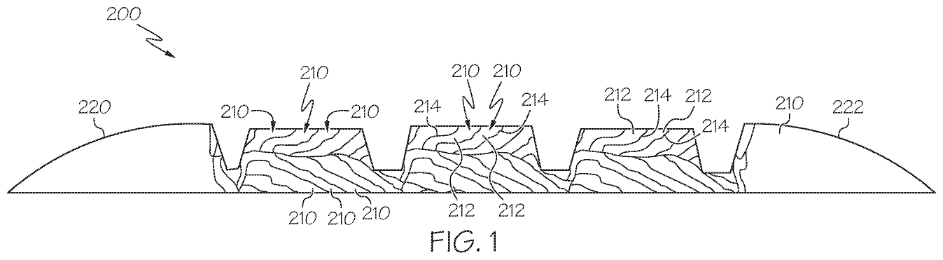

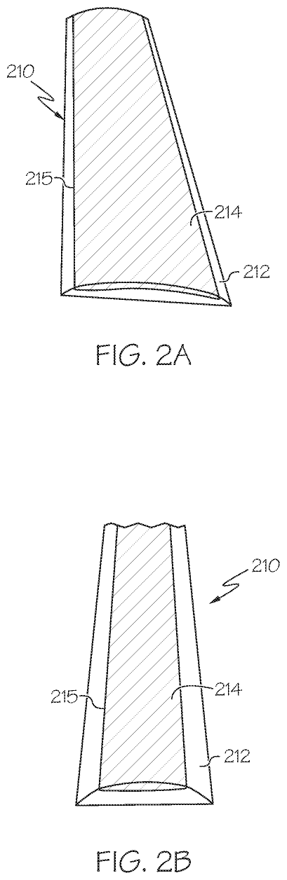

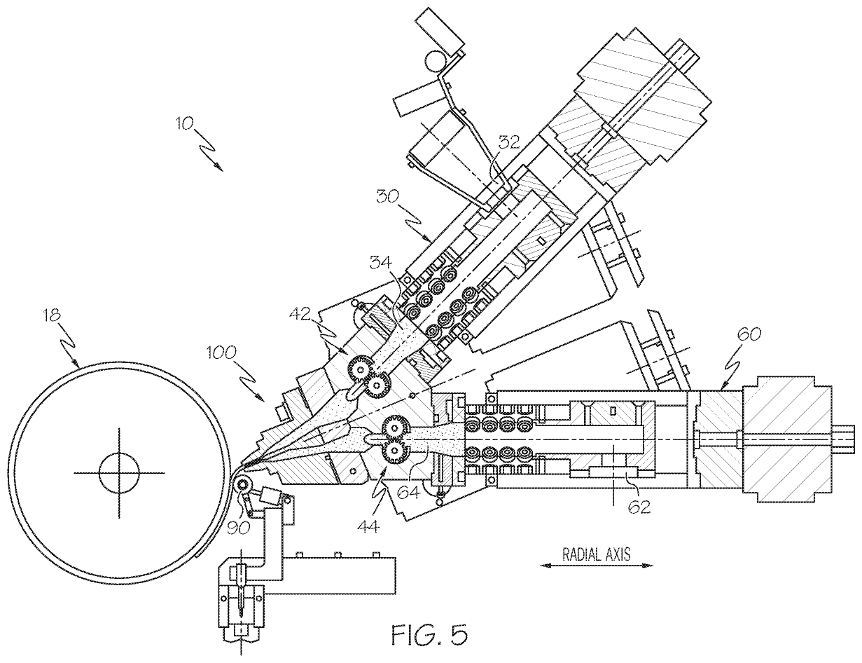

FIG. 1 illustrates a cross-sectional view of a post cure tire tread 200 of the present invention. The tire tread 200 is formed by winding a continuous coextruded strip 210 of green rubber onto a tire building drum 18 or a shaped green carcass. The continuous strip 210 is shown in FIG. 2A, and is a dual layer or coextruded strip of a first layer 212 and second layer 214 of two different rubber tread compounds. The first layer 212 is formed from a first rubber compound which can be any mono cap tread compound, typically full silica and nonconductive rubber. The second layer 214 is formed from a second compound that is an electrically conductive rubber compound. The first and second rubber layers 212,214 are formed in discrete layers, and thus are not mixed together. The second layer 214 is preferably thinner than the first layer 212. The coextruded strip shown in FIG. 2A has a ratio of 90% of the first compound to 10% of the second compound, while FIG. 2B illustrates a coextruded strip having a ratio of 95% of the first compound to 5% of the second compound. The coextruded strip has a first outer surface and a second outer surface, and an interface where the first and second compounds are joined together. The orientation of these surfaces may be varied. The apparatus used to form the continuous coextruded strip is described in the paragraphs below, and is shown in FIG. 5. The apparatus can form the coextruded strip while instantaneously varying the ratio of the first compound to the second compound.

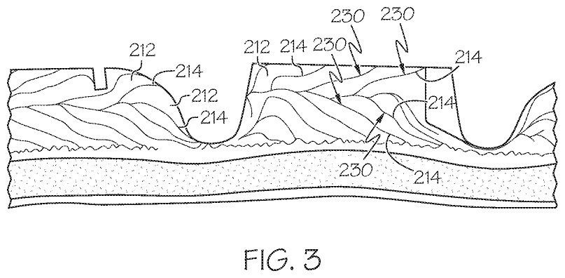

The coextruded strip forming apparatus 10 is used to form the tread shown in FIG. 1 by rotating the drum 18 (or carcass) and then applying a continuous coextruded strip by spirally winding the strip onto the drum 18 or carcass. As shown in FIGS. 1 and 3, the strips are layered in the first row by overlapping the coextruded strip windings with each other. At the lateral ends, 220,222 the strip is preferably 100% of the first compound, which means there are no microchimneys formed in this tread zone. Between the lateral ends 220,222 the strip composition is preferably in the range of 80-90% first compound, and 10-20% of an electrically conductive tread compound. There are typically two rows of strips stacked on top of each other to form the tread. The strips are arranged so that each of the electrically conductive layers 214 of the coextruded strip are in contact with an adjacent electrically conductive layer of an adjacent coextruded strip to form an electrically conductive pathway 230. FIG. 3 illustrates one example of how the coextruded strips are arranged to create an electrically conductive pathway 230.

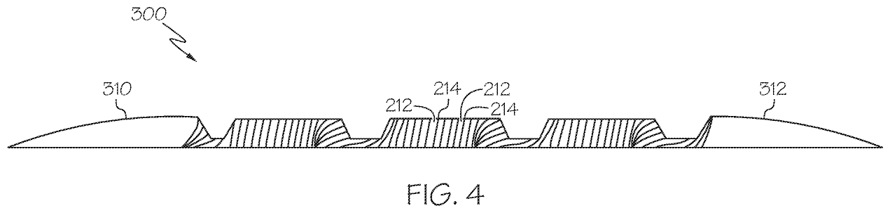

FIG. 4 illustrates a second embodiment of a green tire tread 300 formed from a single layer of coextruded strips. The outer lateral edges 310,312 are formed of 100% of the black compound, while the midportion between the lateral edges are coextruded strips of a first layer 212 and an electrically conductive second layer 214, wherein the first layer 212 is formed of 95% of a first compound while the second layer is formed with 5% of an electrically conductive compound. The strips are stacked vertically so that the outer surfaces or interface of the strips are oriented in the radial direction. The first compound can be selected to be any mono cap tread compound, typically full silica and nonconductive rubber. The second compound could preferably be an electrically conductive rubber compound, or a rubber compound selected for wear, cornering stiffness or wet grip. The advantage to this tire tread is that there is no change of tire properties with wear.

Coextruded Strip Forming Apparatus

As shown in FIG. 5, the coextruded strip forming apparatus 10 includes a first extruder 30 and a second extruder 60, preferably arranged side by side in close proximity. The first extruder 30 has an inlet 32 for receiving a first rubber composition A, while the second extruder 60 has an inlet 62 for receiving a second rubber composition B. Each extruder functions to warm up the rubber composition to the temperature in the range of about 80° C. to about 150° C., preferably about 90° C. to about 120° C., and to masticate the rubber composition as needed. The coextruded strip forming apparatus 10 is mounted upon a translatable support bar 16, that can translate fore and aft in relation to a tire building machine 18.

The first compound A is extruded by the first extruder 30 and then pumped by the first gear pump 42 into a nozzle 100, while at the same time the second compound B is extruded by the second extruder 60 and then pumped by the second gear pump 44 into the coextrusion nozzle 100.

The coextrusion nozzle 100 has a removable insert 120 that functions to divide the nozzle into a first and second flow passageway 122,124. The removable insert 120 is preferably rectangular in cross-sectional shape. The removable insert 120 has a distal end 130 with tapered ends 132,134 forming a nose 136. The nose 136 is positioned adjacent the nozzle die exit 140 and spaced a few millimeters from the die exit 140. The region between the nose 136 and the die exit 140 is a low volume coextrusion zone 150 that is high pressure. In the low volume coextrusion zone 150, compound A flowstream 122 merges with compound B flowstream 124 forming two discrete layers 212,214 joined together at an interface 215.

The volume ratio of compound A to compound B may be changed by varying the ratio of the speed of gear pump of compound A to the speed of gear pump of compound B. The dual coextruded strip forming apparatus 10 can adjust the speed ratios on the fly, and due to the small residence time of the coextrusion nozzle, the apparatus has a fast response to a change in the compound ratios. This is due to the low volume of the coextrusion zone.

The tread having a plurality of microchimneys as described herein is beneficial for cycle time since it replaces the job of two single gear pumps with one, and eliminates the sequence starts/stops that are required when switching from one gear pump to the other. The microchimney design is also a more robust solution because it provides multiple conductive paths throughout the tread as opposed to a single path, resolving issues with conventional chimney designs as a result of issues/inconsistencies with the extrusion, the conduction path can be broken and the tire will not properly dissipate the built up static charge. This concept also eliminates the complexity of splice bar design and die work. The microchimney layout can easily be modified with programming changes.

Variations in the present inventions are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A method for forming a composite tread with microchimneys, the method comprising the steps of:
providing a coextruded strip formed of a first compound and a second compound, wherein the first compound is a tread compound, and the second compound is electrically conductive, and then winding the coextruded strip onto a tire building drum to form a tread.

2. The method of claim 1 wherein the coextruded strip is spirally wound onto the tire building drum.

3. The method of claim 1 wherein the lateral edges of the tread are 100% of the first compound.

4. The method of claim 1 wherein the midsection of the tread is formed from a coextruded strip of 90% first compound and 10% second compound.

5. The method of claim 1 wherein the tread is formed from a single layer of coextruded strips.

6. The method of claim 5 wherein the coextruded strips have a first and second outer surface that are aligned with the radial direction.

7. The method of claim 1 wherein the tread is formed from a first and second layer of coextruded strips, wherein the coextruded strips are wound so that the second compound of the coextruded strips of the first layer are in contact with the second compound of the coextruded strips of the second layer.

8. The method of claim 1 wherein one of the lateral edges of the tread is formed from 100% compound A, and the other lateral edge is formed from 90% of the first compound and 10% of the second compound.

9. The method of claim 1 wherein the coextruded strip is formed comprising the steps of:
extruding the first compound through a first extruder and a first gear pump and into a first passageway of a coextrusion nozzle;
extruding the second compound B through a second extruder and a second gear pump and into a second passageway of the coextrusion nozzle; and
wherein the first and second passageways are joined together immediately upstream of the die outlet of the coextrusion nozzle.

10. The method of claim 9 wherein the coextrusion nozzle has an insert which divides the nozzle into a separate first and second passageway.

11. The method of claim 10 wherein the insert has a distal end for positioning adjacent a die outlet of the coextrusion nozzle, wherein the distal end has an elongated flat portion.

12. The method of claim 11 wherein the ratio of the volume of the first compound to the second compound is varied by changing the ratio of the speed of the first gear pump to the second gear pump.

13. The method of claim 12 wherein the ratio of the first gear pump to the second gear pump may be varied during operation of the system.

14. The method of claim 13 wherein the insert is removable.

15. The method of claim 13 wherein the insert has a rectangular cross-sectional shape.

16. The method of claim 1 wherein the strip is formed in a continuous manner.

17. The method of claim 1 wherein the strip is applied in a continuous manner to a tire building machine to build a tire component.

18. A tire having a tread, wherein the tread is formed from spirally winding a coextruded strip of rubber, wherein the strip of rubber is formed from a dual layer of a first rubber compound and a second layer of compound, wherein the second layer of compound is electrically conductive.

19. The tire of claim 18 wherein the continuous coextruded strip has a rectangular cross-sectional shape.

20. The tire of claim 18 wherein the continuous coextruded strip has a trapezoidal cross-sectional shape.

21. The tire of claim 18 wherein the lateral edges of the tread are 100% of a first compound.

22. The tire of claim 18 wherein the midsection of the tread is formed from a continuous strip of 90% first compound and 10% second compound.
